(19) United States
(12) Patent Application Publication
(10) Pub. No.: US 2014/0116220 A1
(43) Pub. Date: May 1, 2014

(54) TABLE SAW HOLD DOWN FOR WIDE WORK PIECES

(71) Applicant: WILLIAM NIICHEL, PUEBLO WEST, CO (US)

(72) Inventor: WILLIAM NIICHEL, PUEBLO WEST, CO (US)

(21) Appl. No.: 14/070,140

(22) Filed: Nov. 1, 2013

Related U.S. Application Data
(60) Provisional application No. 61/721,396, filed on Nov. 1, 2012.

(51) Int. Cl. B23D 51/04

(52) U.S. Cl. CPC B23D 51/04
USPC 83/451

(57) ABSTRACT

A safety hold down device is provided for use with a conventional table saw. In one embodiment, the device comprises an elongate base member that slideably nests in a recessed channel formed in the work surface of the table saw. An elongate hold down arm engages the base member to secure an oversized work piece there between. An alignment mechanism is pivotally secured to the base member to abut and align the work piece relative to the saw blade. The alignment mechanism is repositionable relative to the base member to provide a range of positions for orienting the work piece. Adjustable alignment pins may optionally be provided to abut a surface or edge of a work piece, regardless of the shape or contour of the surface or edge.

### CROSS REFERENCE TO RELATED APPLICATIONS

The present application claims the benefit of U.S. Provisional Application Ser. No. 61/721,396 filed Nov. 1, 2012 entitled “Table Saw Hold Down for Wide Work Pieces,” the entirety of which is incorporated herein by this reference.

### FIELD OF THE INVENTION

The present invention relates to a safety apparatus for use with table saws to accommodate cutting of work pieces that are of an extra wide dimension. The hold down device is designed to mate with a guide channel formed in the surface of a table saw and, thus, requires no modification to the table saw.

### BACKGROUND OF THE INVENTION

A conventional table saw has a surface of a generally standard dimension. However, there are often instances when the surface of a table saw is not large enough to accommodate wide work pieces, such as standard 8 and 4 foot sheets of plywood. The excess length of the work piece extends substantially beyond the supporting surface of the table saw, creating problems with support as well as work piece kickback during cutting. Another example of a situation that requires cutting along the short dimension of a wide work piece include trimming the bottom edge of a door, as may be needed to accommodate installation of tile or other flooring. Normally these types of cuts are accomplished by a hand saw and the result is an uneven and less than aesthetically pleasing result. Embodiments of the present invention allow such cuts to be made on a conventional table saw, improving the quality of the cut while doing so in a safe manner.

### SUMMARY OF THE INVENTION

It is an object of the present invention to provide for a novel and improved safety hold down device for use with a conventional table saw and oversized work pieces.

In one embodiment, a safety hold down device is provided which accommodates a range of oversized work pieces. An elongate base member is provided which nests and slideably fits in a channel formed in the work surface of the table. Alignment means is provided at one end of the base member to align or orient a work piece relative to the saw blade. The alignment means is adjustable to vary the position of the work piece relative to the saw blade. In one embodiment the alignment means comprises a base plate and an upstanding alignment plate which are angularly positionable relative to the base member. Adjustable alignment pins may be optionally interconnected to the alignment plate and provide abutment surfaces to engage a work piece. The alignment pins are adjustable to move in a plane parallel to the work surface and may be adjusted to interface with work pieces having a straight or irregular edge. An elongate hold down member is further provided and is secured to the base member by a plurality of locking members. A work piece is positioned between the base member and the hold down member. By securing the two component pieces together, the work piece is safely secured for purposes of undergoing a cutting operation. The work piece and the safety hold down device are moved past the cutting blade to make the desired cut. In this manner, an oversized work piece may be safely secured and safely cut with reduced concern for kickback.

These and other advantages will be apparent from the disclosure of the invention(s) contained herein. Various embodiments of the present invention are set forth in the attached figures and in the detailed description of the invention as provided herein and as embodied by the claims. It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings, which are incorporated in and constitute a part of the specification, illustrate embodiments of the invention and together with the general description of the invention and the detailed description of the drawings herein, serve to explain the principles of these inventions.

FIG. 1 is a top plan view of one embodiment of the present invention.

FIG. 2 is an elevation view of the embodiment of FIG. 1.

FIG. 3 is a top plan view of an embodiment of the present invention positioned on a table saw and holding a work piece.

FIGS. 4A, 4B and 4C are elevational views of an embodiment of the hold down device of the present invention accommodating work pieces of different thickness.

FIG. 5 is a partial elevational view of an embodiment of the hold down device of the present invention without a work piece.

FIG. 6 is an exploded perspective view of the hold down device shown in FIGS. 1 and 2.

FIG. 7 is a partial top plan view of the alignment mechanism of one embodiment of the hold down device, oriented at a position perpendicular to a table saw blade.

FIG. 8 is a partial top plan view of the alignment mechanism of one embodiment of the hold down device, oriented such that the work piece is at an angle relative to the orientation of the saw blade.

While the following disclosure describes the invention in connection with those embodiments presented, one should understand that the invention is not strictly limited to these embodiments. Furthermore, one should understand that the drawings are not necessarily to scale, and that in certain instances, the disclosure may not include details which are not necessary for an understanding of the present invention, such as conventional details of fabrication and assembly.

### DETAILED DESCRIPTION

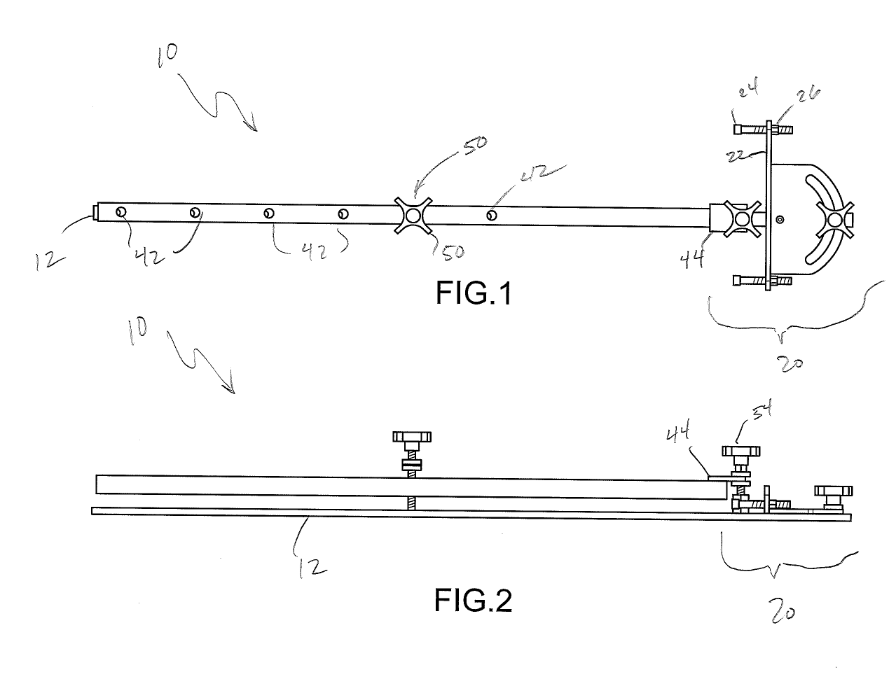

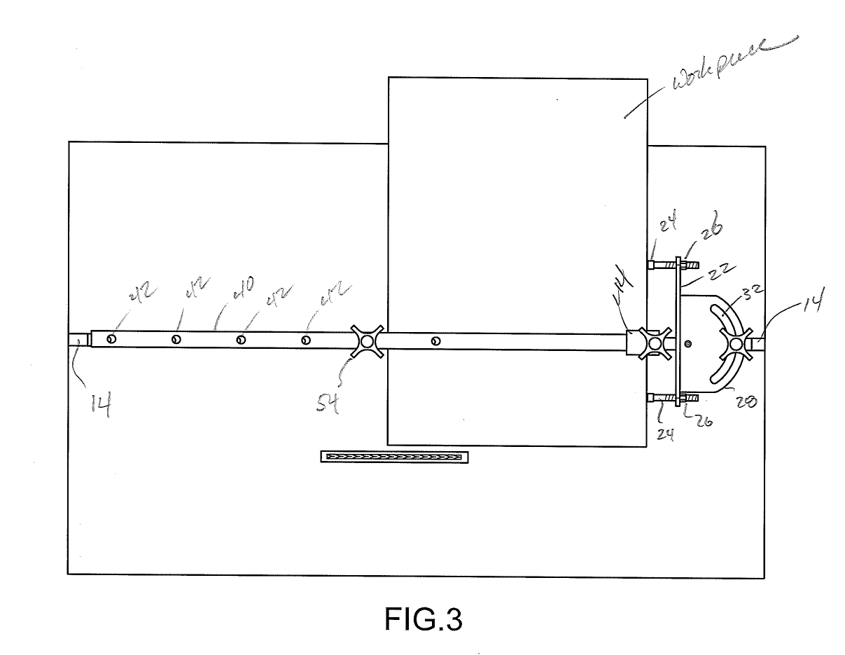

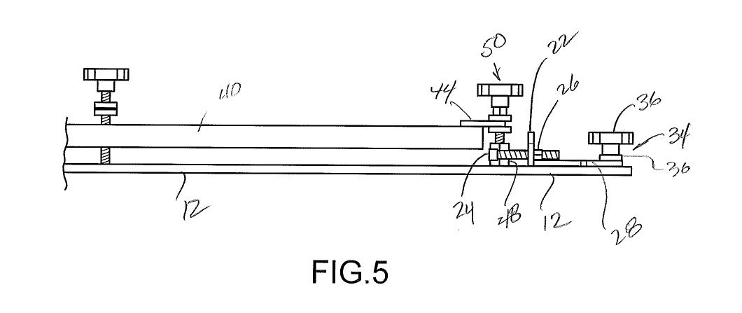

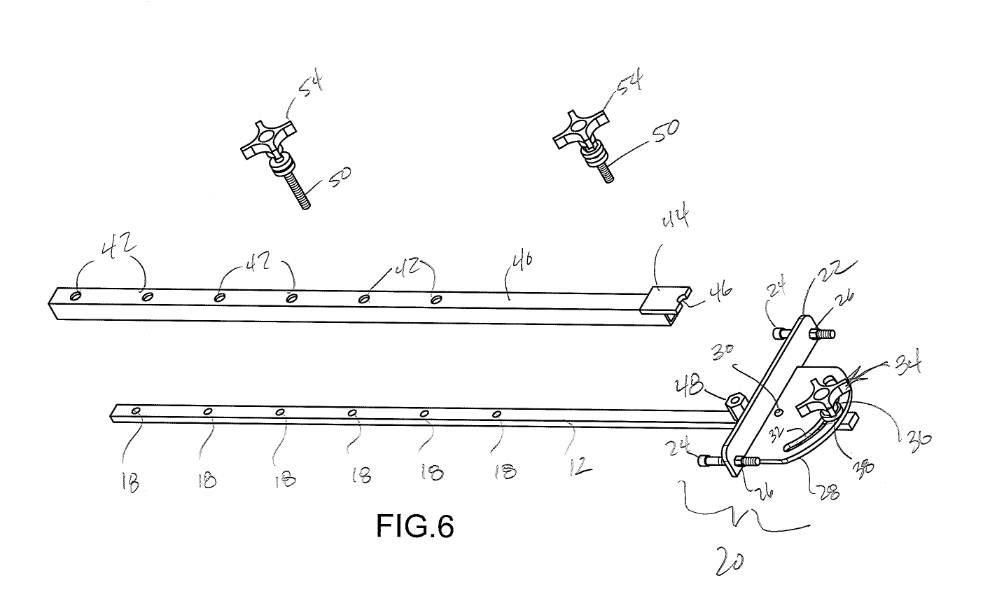

Turning to FIGS. 1, 2, 5 and 6, one embodiment of a hold down device for a table saw is illustrated. The hold down device 10 comprises a base member 12 which is an elongate metal bar. The base member is dimensioned to slidingly engage guide channels 14 formed in the surface of a conventional table saw 16 (see FIG. 3). The base member 12 includes a plurality of threaded apertures 18 and an alignment mechanism 20 is positioned at one end of the elongate base member 12.

In the illustrated embodiment, the alignment mechanism 20 includes an alignment plate 22 and threaded alignment pins 24. In at least one embodiment, the alignment pins 24 are optional. The alignment pins 24 extend outwardly from the alignment plate 22 to engage a work piece. Threaded nuts 26 lock the position of the alignment pins 24 relative to the alignment plate 22 at a desired distance. The alignment pins 24 are adjustable to accommodate a work piece having a straight or irregularly contoured edge. If the alignment pins 24 are not present, the alignment plate 22 abuts the work piece. The alignment plate 22 is secured to a base plate 28 which is pivotally secured to the base member 12 by a pivot pin 30. An arcuate slot 32 is formed in the base plate 28 and receives a lock down bolt 34 which extends through the slot 32 and engages a threaded aperture (not shown) formed in the base member 12. The lock down bolt 34 has a knob or handle 36 and may include one or more spacers 38 depending upon its length. The lock down bolt 34 secures the position of the alignment mechanism 20 relative to the base member 12. Markings may be provided on the base plate to identify angular positions of the alignment mechanism relative to the base member and the saw blade of the table saw.

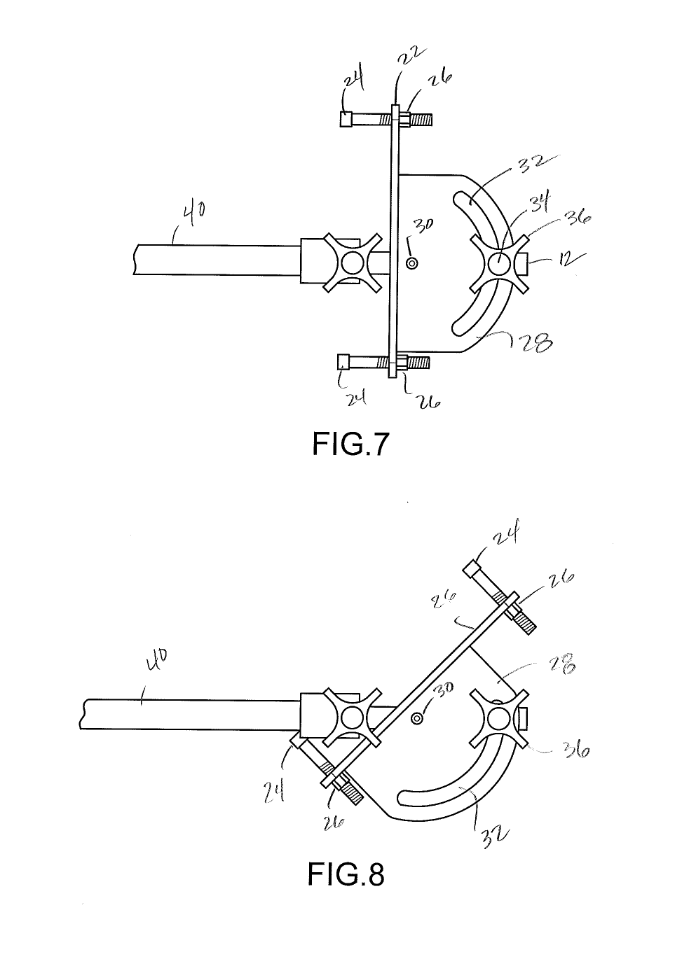

The alignment mechanism 20 is illustrated in FIG. 7 at an orientation in which the alignment plate 22 is perpendicular to the blade of the table saw. As shown, the threaded alignment pins 24 may be repositioned depending upon the nature or shape of the work piece. For example, the pins may be adjusted to accommodate a work piece with a straight or irregular shaped edge. In comparison, as illustrated in FIG. 8, the alignment mechanism 20 is repositioned such that the alignment plate 22 and threaded alignment pins 24 are oriented at a non-perpendicular position relative to the blade of the table saw. By loosening the lock down bolt 34, the alignment mechanism may be repositioned through a range of angles to accommodate different desired cuts.

Returning to FIGS. 1, 2, 5 and 6, the lock down device 10 further includes a hold down arm 40. As shown, the hold down arm 40 is an elongate tubular member with a plurality of apertures 42 formed therein. The apertures 42 align with the threaded apertures 18 and a base member 12 when the hold down arm 40 is properly positioned. The hold down arm 40 further includes a hold down bracket 44 which is formed with an arcuate recess or cutout 46 at the lateral edge thereof. As shown, the hold down bracket 44 is attached to and extends from one surface of the hold down arm 40 but could, alternatively, extend in a planar fashion from the surface of the hold down arm 40. As also illustrated, a threaded boss 48 is affixed to the base member 12. A lock down bolt 50 is received by the threaded boss 48, and spacers 52 seated on the threaded lock down bolt 50 engage and secure one end of the hold down bracket 44 relative to the threaded boss 48. A knob 54 is provided for facilitating use of the lock down bolt 50. A second lock down bolt 50 is also provided to secure the opposite end of the hold down arm 40 relative to the base member 12 through any of the corresponding apertures 42 and threaded apertures 18 as shown in FIGS. 1, 2 and 5.

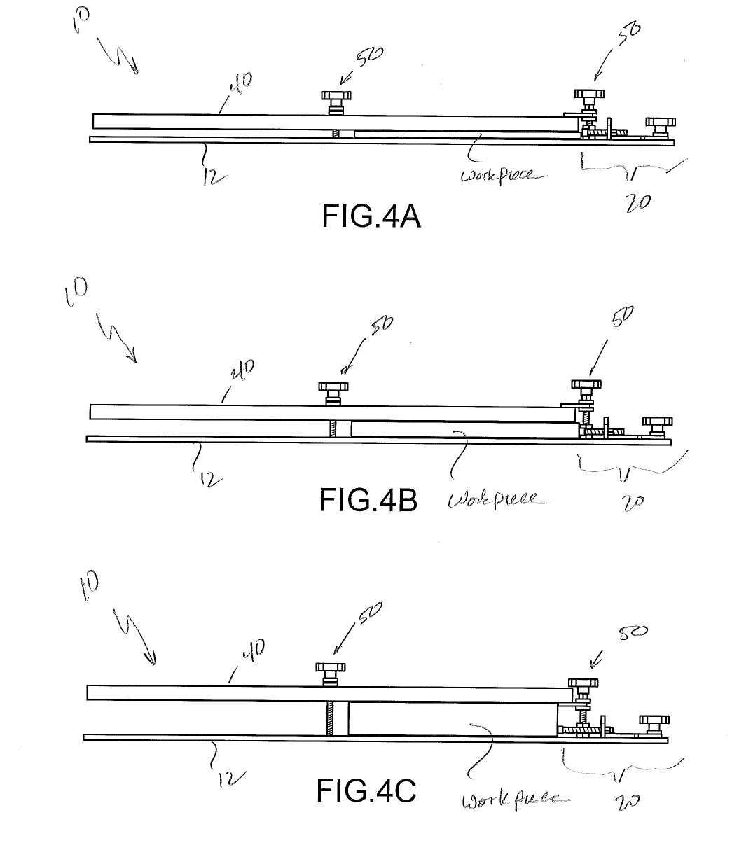

FIGS. 4A, 4B and 4C illustrate the hold down device 10 of the present invention in combination with three different work pieces of different thickness. FIG. 4A shows a work piece secured by the hold down device 10 of a relatively narrow thickness. The lock down bolts 50 secure the hold down arm 40 to the base member 12 on opposite sides of the work piece. FIG. 4B shows a work piece of greater thickness also accommodated by the lock down device of the present invention. FIG. 4C shows a third variety of work piece of an even greater thickness. In this embodiment, the hold down arm has been rotated 180 degrees such that the hold down bracket 44 is oriented underneath the hold down arm, rather than on top of the hold down arm. In this manner, work pieces of even greater thickness may be accommodated.

Turning to FIG. 3, the hold down device 10 of the present invention is shown positioned on a table saw 16. The surface of the table saw is provided with at least one guide channel 14. Dimensions of the guide channel and the dimensions of the base plate 12 are such that the base plate 12 fits securely within the guide channel 14 but can slide within the guide channel. As shown, a work piece having a width W greater than its length L is secured by the hold down device 10. One edge of the work piece abuts the threaded alignment pins 24. The work piece is secured between the base member 12 and hold down arm 40 by the lock down bolts 50. In this manner, the work piece and the lock down device 10 may be moved through the cutting zone of the blade of the table saw to perform a cut in the work piece as desired without risk of kickback and with full support of the work piece.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. For example, the apertures 18 in the base member 12 may be unthreaded and sized to secure and prevent rotation of a bolt head. An appropriately sized bolt may be positioned upwardly through the base member and through the apertures 42 of the hold down arm 40. A nut or similarly threaded knob may then be secured to the upstanding bolt to secure the hold down arm relative to the base member. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A safety device for a powered table saw, the table saw including a flat work surface having one or more elongate recessed channels, a saw blade extending through a slot in the table and a motor for rotating the saw blade at a high rotational speed, the safety device comprising:
a. an elongate base member adapted to fit in an elongated recessed channel on the work surface of a table saw, the elongate base member having a plurality of threaded apertures spaced along its length;
b. an elongate hold down arm having a plurality of apertures spaced along its length and wherein the spacing of the apertures on the hold down arm is substantially the same as the spacing of the apertures in the base member; and
c. a work piece alignment mechanism pivotally attached to the base member proximate one end of the base member, the alignment mechanism comprising an alignment plate disposed substantially perpendicular to the base member, a plurality of alignment pins extending from the alignment plate, and a locking mechanism adapted to secure the position of the alignment mechanism relative to the base member; and,
d. A plurality of lock bolts adapted to lock the hold down member relative to the base member by passing through the apertures in the hold down member and engaging the threaded apertures in the base member.

2. The safety device of claim 1, wherein the hold down arm comprises a tubular member having a top surface and a bottom surface spaced from the top surface, and a hold down bracket is disposed at one end of the hold down member and affixed to one of the top or bottom surfaces.

3. The safety device of claim 2, wherein the hold down member is reversibly positionable to accommodate work pieces of different thicknesses by having either the top or bottom surface facing the base member.

4. The safety device of claim 1, wherein the alignment mechanism further comprises a base plate disposed substantially parallel to the base member and having a slot and predetermined markings positioned adjacent the slot for positioning the alignment plate at a range of angular positions relative to the base member, and a locking mechanism for securing the position of the base plate relative to the base member.

5. The safety device of claim 4, wherein the locking mechanism is a bolt that extends through the slot and engages a threaded aperture in the base member.

6. The safety device of claim 1, wherein the plurality of alignment pins are adjustably positionable relative to the alignment plate.

7. The safety device of claim 6, where in the plurality of alignment pins have an abutment end adapted to interface with a work piece.

8. The safety device of claim 6, wherein the alignment plate has a plurality of threaded apertures, the alignment pins have a threaded portion to engage the threaded aperture, and a lock nut secures the position of the pins relative to the alignment plate.

9. The safety device of claim 1, further comprising spacers adapted to receive the lock bolts to alter the spacing between the hold down member and base member when the hold down member is secured to the base member.

10. A safety device for a powered table saw, the table saw including a flat work surface having an elongate recessed channel, the safety device comprising:
a. an elongate base member adapted to fit in an elongated recessed channel on the work surface of a table saw, the elongate base member having a plurality of apertures spaced along its length;
b. a hold down arm having a plurality of apertures spaced along its length, wherein the spacing of the apertures on the hold down arm is substantially the same as the spacing of the apertures in the base member;
c. A plurality of lock members adapted to cooperate with the apertures in the base member and the hold down arm to lock the hold down arm relative to the base member; and
d. alignment means attached to the base member proximate one end of the base member and adapted to engage a work piece, the alignment means positionable between a range of positions to orient a work piece at different positions relative to the orientation of the blade of the table saw.

11. The safety device of claim 10, wherein the lock members comprise a plurality of threaded bolts and complementary threaded securement members.

12. The safety device of claim 11, wherein the complementary threaded securement members are threaded apertures in the base member.

13. The safety device of claim 10, wherein the alignment means comprises an alignment plate disposed substantially perpendicular to the base member, and a plurality of alignment pins extending from the alignment plate.

14. The safety device of claim 13, wherein the alignment means further comprises a base plate rotatably secured to the base member, disposed substantially parallel to the base member and having a slot, and a locking mechanism extending through the slot and engaging the base member, the locking mechanism for securing the position of the base plate relative to the base member.
